(19) United States
(12) Patent Application Publication
(10) Pub. No.: US 2005/0192366 A1
(43) Pub. Date: Sep. 1, 2005

(54) Ormosil aerogels containing silicon bonded polymethacrylate

(75) Inventors: Duan Li Ou, Framingham, MA (US); George L. Gould, Mendon, MA (US); Christopher John Stepanian, Somerville, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aspen Aerogels, Inc., Northborough, MA (US)

(21) Appl. No.: 11/030,014

(22) Filed: Jan. 5, 2005

Related U.S. Application Data
(60) Provisional application No. 60/534,804, filed on Jan. 6, 2004.

(51) Int. Cl. C08J 9/28

(52) U.S. Cl. 521/64

(57) ABSTRACT

The invention provides reinforced aerogel monoliths as well as fiber reinforced composites thereof for a variety of uses. Compositions and methods of preparing the monoliths and composites are also provided.

### CROSS-REFERENCES TO RELATED APPLICATIONS

This application claims benefit of priority from U.S. Provisional Patent Application 60/534,804, filed Jan. 6, 2004, which is hereby incorporated in its entirety as if fully set forth.

### STATEMENT REGARDING FEDERALLY SPONSORED RESEARCH OR DEVELOPMENT

This invention was partially made with Government support under Contract NAS09-03022 (an SBIR Grant) awarded by the National Aeronautics and Space Administration (NASA). The Government has certain rights in parts of this invention.

### FIELD OF THE INVENTION

The inventions described herein relate to producing solvent filled, nanostructured gel structures and fiber reinforced gel composites. These materials become nanoporous aerogel structures after all the mobile phase solvents are extracted via a process such as supercritical fluid extraction (hypercritical solvent extraction). Formulations and manufacturing processes relating to the composites and aerogel structures are provided, along with methods of using them based on their improved mechanical properties.

### BACKGROUND OF THE INVENTION

Aerogels describe a class of material based upon their structure, namely low density, open cell structures, large surface areas (often 900 m²/g or higher) and sub-nanometer scale pore sizes. Supercritical and subcritical fluid extraction technologies are commonly used during manufacture to extract fluid from the fragile cells without causing their collapse. Because the name aerogel describes a class of structures rather than a specific material, a variety of different aerogel compositions are known and include inorganic, organic and inorganic/organic hybrid compositions. (N. H [symbol] sing and U Schubert, Angew. Chem. Int. Ed. 1998, 37, 22-45).

Inorganic aerogels are generally based upon metal alkoxides and include materials such as silica, various carbides, and alumina. Organic aerogels include, but are not limited to, urethane aerogels, resorcinol formaldehyde aerogels, and polyimide aerogels. Organic/inorganic hybrid aerogels are mainly ormosil (organically modified silica) aerogels. The organic components in this preferred embodiment are either dispersed throughout or chemically bonded to the silica network. Dispersed or weakly bonded organic materials have been shown to be relatively easy to wash out of the gel structure throughout the manufacturing process. Organic materials that are covalently bonded to the inorganic structures would significantly reduce, or eliminate, the amount of washout.

Low-density aerogel materials (0.01-0.3 g/cc) are widely considered to be the best solid thermal insulators, significantly better than the best rigid foams (e.g. polyisocyanurate, polyurethane, etc.). For instance, aerogel materials often have thermal conductivities of less than 15 mW/m-K and below at 37.8° C. and one atmosphere of pressure (see J. Fricke and T. Tillotson, Thin Solid Films, 297 (1997) 212-223). Aerogels function as thermal insulators primarily by minimizing conduction (low density, tortuous path for heat transfer through the solid nanostructure), convection (very small pore sizes minimize convection), and radiation (IR absorbing or scattering dopants are readily dispersed throughout the aerogel matrix). Depending on the formulation, they can function well from cryogenic temperatures to 550° C. and above. At higher temperatures, aerogel structures have a tendency to shrink and sinter, losing much of their original pore volume and surface area. Aerogel materials also display many other interesting acoustic, optical, mechanical, and chemical properties that make them useful in both consumer and industrial markets.

Low-density insulating materials have been developed to solve a number of thermal isolation problems in applications in which the core insulation experiences significant compressive forces. For instance, polymeric materials have been compounded with hollow glass microspheres to create syntactic foams, which are typically very stiff, compression resistant materials. Syntactic materials are well known as insulators for underwater oil and gas pipelines and support equipment. Syntactic foam materials are well known as insulators for underwater oil and gas pipelines and support equipment. Syntactic materials are relatively inflexible, and have a high thermal conductivity relative to flexible aerogel composites (aerogel matrices reinforced by fiber) produced by Aspen Aerogels, Inc.

Aerogels can be formed from gel precursors. Various layers, including flexible fiber-reinforced aerogels, can be readily combined and shaped to give pre-forms that when mechanically compressed along one or more axes, give compressively strong bodies along any of those axes. Aerogel bodies that are compressed in this manner exhibit much better thermal insulation values than syntactic foams. Methods to improve the physical properties of these materials such as optimizing density, improving thermal resistivity and minimizing dustiness will facilitate large-scale use of these materials in a variety of industries and applications including underwater oil and gas pipelines as external insulation.

Silica aerogels are normally fragile when they are composed of a low density ceramic or cross-linked polymer matrix material with entrained solvent (gel solvent). They must be handled or processed with great care.

Although the diffusion of polymerized silica chains and subsequent solid network growth are significantly slowed within the silica gel structure after the silica gelation point, the maintenance of the original gel liquid (mother liquor) for a period of time after gelation is known in the art to be essential to obtaining an aerogel that has the best thermal and mechanical properties. This period of time that the gel “ages” without disturbance is called “syneresis”. Syneresis conditions (time, temperature, pH, solid concentration) are important to the aerogel product quality.

Conventional methods for monolithic gel and/or fiber-reinforced composite gel production formed via sol-gel chemistry described in the patent and scientific literature invariably involve batch casting. Batch casting is defined here as catalyzing one entire volume of sol to induce gelation simultaneously throughout that volume. An alternate process to form monolithic and/or fiber-reinforced composite gel structures has been described in published U.S. patent application document U.S. 20020094426A1, wherein sols are catalyzed (in the presence of fiber in the case of fiber-reinforced composites) in a continuous stream prior to gelation. Gel-forming techniques are well-known to those trained in the art. Examples include adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3). Suitable materials for forming inorganic aerogels are oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability, low cost, and ease of processing.

It is also known to those trained in the art that organic aerogels can be made from melamine formaldehydes, resorcinol formaldehydes and the like (see for instance N. H [symbol] sing and U Schubert, Angew. Chem. Int. Ed. 1998, 37, 22-45).

The availability of fiber reinforced aerogel composites opened up many application areas for aerogel materials. They allowed for the manufacture of large sections of aerogel composites with most of the useful qualities of aerogels. The composite may be manufactured with higher efficiency, in larger sections, with improved mechanical properties and at a lower price. Vacuum insulation panels is one of such high performance product in thermal insulation market. Low density fiber reinforced silica aerogel shrinks more than 40% under 17.5 psi loading. A different reinforcement method is needed to produce stiffer aerogel composite materials in order to sustain the pressure induced in the VIP structure.

In the past two decades, many investigators have attempted to improve the mechanical properties of silica aerogels and xerogels in order to reduce their tendency to crack during the formation of monolithic gel structures, by the incorporation of a secondly polymeric phase directly bonded to silica network. These led to the synthesis of numerous types of inorganic organic hybrid materials. Some of the most noticeable examples are as follows:

N. Leventis, C. Sotiriou-Leventis, G. Zhang and A. M. Rawashdeh, Nano Letters, 2002, 2(9), 957-960, report the increment of strength of silica aerogel by a factor over 100 through cross-linking the silanols of the silica hydrogels with poly(hexamethylene diisocyanate). The resultant material, however, contains hydrolysable bonds between the silicon and oxygen atoms in —Si—O—C— and no Si—C bonds.

H. Schmidt, J. Non-Cryst. Solid, 73, 681, 1985, reported the increase of the tensile properties of silica xerogel by the incorporation of polymethacrylate (referred as PMA there after).

The following authors also carried out a preparation and systematic structural studies of PMA/Silica xerogels: J. H. Harreld, B. Dunn and J. I. Zink, J. Mater. Chem., 1997, 7(8), 1511-1517; Z. H. Huang and K. Y. Qiu, Polymer, 38(3), 1997, 521-526; D. L. Ou, A. Adamjee, S. L. Lana and A. B. Seddon, Ceramic, Tran., 1998, 10, 291-294; D. Donescu, M. Teodorescu, S. Serban, L. Fusulan, C. Petcu, European Polymer Journal, 35 (1999), 1679-1686. Among this effort, Zink et al and Ou et al reported a method to avoid phase separation to produce transparent PMA/silica xerogels.

To distinguish between aerogels and xerogels, it is pointed out that aerogels are a unique class of materials characterized by their low densities, high pore volumes, and nanometer pore sizes. Because of their high pore volumes and nanometer pore sizes, they typically have high surface areas and low thermal conductivities. The high porosity leads to a low solid thermal conductivity, and the nanometer pore sizes cause partial suppression of gaseous thermal conduction because the pore diameters are typically smaller than the mean free path of gases. This structural morphology of an aerogel is a major advantage in thermal insulation applications. For instance, thermal conductivities have been measured to be less than 15 mW/m·K at ambient conditions for silica aerogels (see J. Fricke and T. Tillotson, Thin Solid Films, 297 (1997) 212-223) and as low as 12 mW/m·K for organic aerogels (such as those composed of resorcinol-formaldehyde, see R. W. Pekala and L. W. Hrubesh, U.S. Pat. No. 5,731,360). This is in sharp contrast to xerogels, which have higher densities than aerogels and are used as a coating such as a dielectric coating.

The sol-gel process has been used to synthesize a large variety of inorganic, organic and fewer hybrid inorganic-organic xerogels, aerogels and nanocomposite materials. Silica gels are frequently used as the base material for inorganic and hybrid inorganic-organic material synthesis. Relevant precursor materials for silica based aerogel synthesis include, but are not limited to, sodium silicates, tetraethylorthosilicate (TEOS), tetramethylorthosilicate (TMOS), monomeric alkylalkoxy silanes, bis trialkoxy alkyl or aryl silanes, polyhedral silsesquioxanes, and others. Various polymers have been incorporated into silica gels to improve mechanical properties of the resulting gels, xerogels (see J. D. Mackenzie, Y. J. Chung and Y. Hu, J. Non-Crystalline solid 147&148 (1992), 271-279, Y. Hu and J. D. Mackenzie. J. Mater. Science, 27, (1992)), and aerogels. (S. J. Kramer, F. Rubio-Alonso and J. D. Mackenzie, MRS Proc. Vol 435, 295-300, 1996) Aerogels are obtained when the gels are dried in a manner that does not alter or causes minimal changes to the structure of the wet gel. This is typically accomplished by removing the solvent phase from the gel above the critical point of the solvent or mixture of solvents if a co-solvent is used to aid the drying process.

A physical admixture of an organic polymer distributed in a silica gel matrix can affect the physical, chemical, and mechanical properties of the resulting hybrid material. Polymeric materials that are weakly bound to the silica gel structure, typically through hydrogen bonding to Si—OH (silanol) structures, can be non-homogeneously distributed throughout the material structure due to phase separation in the manufacturing process. In the case of composite aerogel manufacture, weakly bonded or associated polymer dopants can be washed out during the conversion of alcogels or hydrogels to aerogels during commonly used solvent exchange steps. A straightforward way to improve binding of the dopant polymer or modifier to the composite structure is to selectively react latent silanol functionalities within the fully formed silica gel structure with various reactive moieties (e.g. isocyanates), such as that taught by Leventis et al (Nano Letters, 2002, 2(9), 957-960 and U.S. published application 20040132846A1). If the resulting chemical structure results in a Si—O—X linkage, the group is readily susceptible to hydrolytic scission in the presence of water.

Wet gels frequently exhibit structures with mass fractal features consisting of co-continuous solid and pore liquid phases where the pore liquid phase can occupy as much as 98% of the sample volume. Aerogels have structures that are very similar to that of the original gel because they are dried by supercritical processes that eliminate capillary forces that cause the gel structure to collapse. The structure of xerogels, in contrast, is significantly modified during drying due to the capillary forces acting on the solid network during the evaporative drying process. The magnitude of the capillary pressure exerted on the solid network during evaporation is inversely proportional to pore dimensions (e.g. pore radius), and thus can be extremely large when pore features are in the nanometer (10⁻⁹ meters) range. These surface tension forces created during evaporative drying cause the gel network to fold or condense during xerogel manufacture as the coordination number of the particles increases.

Stated differently, a xerogel is formed upon conventional (evaporative) drying of wet gels, that is by increase in temperature or decrease in pressure with concomitant large shrinkage (and mostly destruction) of the initially uniform gel body. This large shrinkage of a gel body upon evaporation of the pore liquid is caused by capillary forces acting on the pore walls as the liquid retreats into the gel body. This results in the collapse of the filigrane, the highly porous inorganic network of the wet gels. Collapse of the structure stops when the gel network becomes sufficiently strong to resist the compressive forces caused by the surface tension.

The resulting xerogel has a close packing globular structure and no larger pores were observed under TEM, which suggests that they are space filling. Thus the dried xerogel structure (which comprises both the skeletal and porous phases) is a contracted and distorted version of the original wet gel's structure. Because of the difference in drying procedures, xerogels and aerogels have very different structures and material properties. For instance, the surface area, pore volume, and number of sterically accessible pendant reactive groups to a typical Si atom is significantly higher on average in an aerogel structure (dried supercritically) than in the corresponding xerogel structure made with the same starting formulation but dried evaporatively. Stated differently, the solutions or mixtures generally used to prepare a xerogel cannot be used to prepare an aerogel simply by altering the drying conditions because the resultant product will not automatically have a density of an aerogel. Thus there are fundamental compositional differences between xerogels and aerogels that greatly affects their surface area, reactivity, pore volume, thermal conductivity, compressibility, mechanical strength, modulus, and many other properties.

Thus compared to xerogel, aerogels are expanded structures that often more closely resemble the structure of the solvent-filled gel. TEM micrographs of aerogels often reveal a tenuous assemblage of clusters that bound large interstitial cavities. Porosity measurement by nitrogen sorption also reveals the structural difference in nanometer size level, compared to the corresponding xerogel, the aerogel contains over twice the pore volume and the pore size is considerably greater as is evident from the larger amount of adsorption that occurs at high relative pressures (>0.9). See C. J. Brinker and G. W. Scherer, Sol-Gel Science, 1990, Chapter 9. Due to the structural difference between aerogel and xerogels, there is significant difference in the physical properties of these two classes of materials, such as dielectric constant, thermal conductivities, etc. Therefore, even if starting from an identical elemental composition, an aerogel and its corresponding xerogel are completely different materials, somewhat analogous to sugar granules and cotton candy, both of which are composed of the same sugar molecules.

Citation of documents herein is not intended as an admission that any is pertinent prior art. All statements as to the date or representation as to the contents of documents is based on the information available to the applicant and does not constitute any admission as to the correctness of the dates or contents of the documents.

### SUMMARY OF THE INVENTION

Aerogels describe a class of material based upon their structure, namely low density, open cell structures, large surface areas (often 900 m²/g or higher) and sub-nanometer scale pore sizes. Supercritical and subcritical fluid extraction technologies are commonly used during manufacture to extract fluid from the fragile cells without causing their collapse. Because the name aerogel describes a class of structures rather than a specific material, a variety of different aerogel compositions are known and include inorganic, organic and inorganic/organic hybrid compositions. (N. H [symbol] sing and U Schubert, Angew. Chem. Int. Ed. 1998, 37, 22-45).

Inorganic aerogels are generally based upon metal alkoxides and include materials such as silica, various carbides, and alumina. Organic aerogels include, but are not limited to, urethane aerogels, resorcinol formaldehyde aerogels, and polyimide aerogels. Organic/inorganic hybrid aerogels are mainly ormosil (organically modified silica) aerogels. The organic components in this preferred embodiment are either dispersed throughout or chemically bonded to the silica network. Dispersed or weakly bonded organic materials have been shown to be relatively easy to wash out of the gel structure throughout the manufacturing process. Organic materials that are covalently bonded to the inorganic structures would significantly reduce, or eliminate, the amount of washout.

Low-density aerogel materials (0.01-0.3 g/cc) are widely considered to be the best solid thermal insulators, significantly better than the best rigid foams (e.g. polyisocyanurate, polyurethane, etc.). For instance, aerogel materials often have thermal conductivities of less than 15 mW/m-K and below at 37.8° C. and one atmosphere of pressure (see J. Fricke and T. Tillotson, Thin Solid Films, 297 (1997) 212-223). Aerogels function as thermal insulators primarily by minimizing conduction (low density, tortuous path for heat transfer through the solid nanostructure), convection (very small pore sizes minimize convection), and radiation (IR absorbing or scattering dopants are readily dispersed throughout the aerogel matrix). Depending on the formulation, they can function well from cryogenic temperatures to 550° C. and above. At higher temperatures, aerogel structures have a tendency to shrink and sinter, losing much of their original pore volume and surface area. Aerogel materials also display many other interesting acoustic, optical, mechanical, and chemical properties that make them useful in both consumer and industrial markets.

Low-density insulating materials have been developed to solve a number of thermal isolation problems in applications in which the core insulation experiences significant compressive forces. For instance, polymeric materials have been compounded with hollow glass microspheres to create syntactic foams, which are typically very stiff, compression resistant materials. Syntactic materials are well known as insulators for underwater oil and gas pipelines and support equipment. Syntactic foam materials are well known as insulators for underwater oil and gas pipelines and support equipment. Syntactic materials are relatively inflexible, and have a high thermal conductivity relative to flexible aerogel composites (aerogel matrices reinforced by fiber) produced by Aspen Aerogels, Inc.

Aerogels can be formed from gel precursors. Various layers, including flexible fiber-reinforced aerogels, can be readily combined and shaped to give pre-forms that when mechanically compressed along one or more axes, give compressively strong bodies along any of those axes. Aerogel bodies that are compressed in this manner exhibit much better thermal insulation values than syntactic foams. Methods to improve the physical properties of these materials such as optimizing density, improving thermal resistivity and minimizing dustiness will facilitate large-scale use of these materials in a variety of industries and applications including underwater oil and gas pipelines as external insulation.

Silica aerogels are normally fragile when they are composed of a low density ceramic or cross-linked polymer matrix material with entrained solvent (gel solvent). They must be handled or processed with great care.

Although the diffusion of polymerized silica chains and subsequent solid network growth are significantly slowed within the silica gel structure after the silica gelation point, the maintenance of the original gel liquid (mother liquor) for a period of time after gelation is known in the art to be essential to obtaining an aerogel that has the best thermal and mechanical properties. This period of time that the gel “ages” without disturbance is called “syneresis”. Syneresis conditions (time, temperature, pH, solid concentration) are important to the aerogel product quality.

Conventional methods for monolithic gel and/or fiber-reinforced composite gel production formed via sol-gel chemistry described in the patent and scientific literature invariably involve batch casting. Batch casting is defined here as catalyzing one entire volume of sol to induce gelation simultaneously throughout that volume. An alternate process to form monolithic and/or fiber-reinforced composite gel structures has been described in published U.S. patent application document U.S. 20020094426A1, wherein sols are catalyzed (in the presence of fiber in the case of fiber-reinforced composites) in a continuous stream prior to gelation. Gel-forming techniques are well-known to those trained in the art. Examples include adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3). Suitable materials for forming inorganic aerogels are oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability, low cost, and ease of processing.

It is also known to those trained in the art that organic aerogels can be made from melamine formaldehydes, resorcinol formaldehydes and the like (see for instance N. H [symbol] sing and U Schubert, Angew. Chem. Int. Ed. 1998, 37, 22-45).

The availability of fiber reinforced aerogel composites opened up many application areas for aerogel materials. They allowed for the manufacture of large sections of aerogel composites with most of the useful qualities of aerogels. The composite may be manufactured with higher efficiency, in larger sections, with improved mechanical properties and at a lower price. Vacuum insulation panels is one of such high performance product in thermal insulation market. Low density fiber reinforced silica aerogel shrinks more than 40% under 17.5 psi loading. A different reinforcement method is needed to produce stiffer aerogel composite materials in order to sustain the pressure induced in the VIP structure.

In the past two decades, many investigators have attempted to improve the mechanical properties of silica aerogels and xerogels in order to reduce their tendency to crack during the formation of monolithic gel structures, by the incorporation of a secondly polymeric phase directly bonded to silica network. These led to the synthesis of numerous types of inorganic organic hybrid materials. Some of the most noticeable examples are as follows:

N. Leventis, C. Sotiriou-Leventis, G. Zhang and A. M. Rawashdeh, Nano Letters, 2002, 2(9), 957-960, report the increment of strength of silica aerogel by a factor over 100 through cross-linking the silanols of the silica hydrogels with poly(hexamethylene diisocyanate). The resultant material, however, contains hydrolysable bonds between the silicon and oxygen atoms in —Si—O—C— and no Si—C bonds.

H. Schmidt, J. Non-Cryst. Solid, 73, 681, 1985, reported the increase of the tensile properties of silica xerogel by the incorporation of polymethacrylate (referred as PMA there after).

The following authors also carried out a preparation and systematic structural studies of PMA/Silica xerogels: J. H. Harreld, B. Dunn and J. I. Zink, J. Mater. Chem., 1997, 7(8), 1511-1517; Z. H. Huang and K. Y. Qiu, Polymer, 38(3), 1997, 521-526; D. L. Ou, A. Adamjee, S. L. Lana and A. B. Seddon, Ceramic, Tran., 1998, 10, 291-294; D. Donescu, M. Teodorescu, S. Serban, L. Fusulan, C. Petcu, European Polymer Journal, 35 (1999), 1679-1686. Among this effort, Zink et al and Ou et al reported a method to avoid phase separation to produce transparent PMA/silica xerogels.

To distinguish between aerogels and xerogels, it is pointed out that aerogels are a unique class of materials characterized by their low densities, high pore volumes, and nanometer pore sizes. Because of their high pore volumes and nanometer pore sizes, they typically have high surface areas and low thermal conductivities. The high porosity leads to a low solid thermal conductivity, and the nanometer pore sizes cause partial suppression of gaseous thermal conduction because the pore diameters are typically smaller than the mean free path of gases. This structural morphology of an aerogel is a major advantage in thermal insulation applications. For instance, thermal conductivities have been measured to be less than 15 mW/m·K at ambient conditions for silica aerogels (see J. Fricke and T. Tillotson, Thin Solid Films, 297 (1997) 212-223) and as low as 12 mW/m·K for organic aerogels (such as those composed of resorcinol-formaldehyde, see R. W. Pekala and L. W. Hrubesh, U.S. Pat. No. 5,731,360). This is in sharp contrast to xerogels, which have higher densities than aerogels and are used as a coating such as a dielectric coating.

The sol-gel process has been used to synthesize a large variety of inorganic, organic and fewer hybrid inorganic-organic xerogels, aerogels and nanocomposite materials. Silica gels are frequently used as the base material for inorganic and hybrid inorganic-organic material synthesis. Relevant precursor materials for silica based aerogel synthesis include, but are not limited to, sodium silicates, tetraethylorthosilicate (TEOS), tetramethylorthosilicate (TMOS), monomeric alkylalkoxy silanes, bis trialkoxy alkyl or aryl silanes, polyhedral silsesquioxanes, and others. Various polymers have been incorporated into silica gels to improve mechanical properties of the resulting gels, xerogels (see J. D. Mackenzie, Y. J. Chung and Y. Hu, J. Non-Crystalline solid 147&148 (1992), 271-279, Y. Hu and J. D. Mackenzie. J. Mater. Science, 27, (1992)), and aerogels. (S. J. Kramer, F. Rubio-Alonso and J. D. Mackenzie, MRS Proc. Vol 435, 295-300, 1996) Aerogels are obtained when the gels are dried in a manner that does not alter or causes minimal changes to the structure of the wet gel. This is typically accomplished by removing the solvent phase from the gel above the critical point of the solvent or mixture of solvents if a co-solvent is used to aid the drying process.

A physical admixture of an organic polymer distributed in a silica gel matrix can affect the physical, chemical, and mechanical properties of the resulting hybrid material. Polymeric materials that are weakly bound to the silica gel structure, typically through hydrogen bonding to Si—OH (silanol) structures, can be non-homogeneously distributed throughout the material structure due to phase separation in the manufacturing process. In the case of composite aerogel manufacture, weakly bonded or associated polymer dopants can be washed out during the conversion of alcogels or hydrogels to aerogels during commonly used solvent exchange steps. A straightforward way to improve binding of the dopant polymer or modifier to the composite structure is to selectively react latent silanol functionalities within the fully formed silica gel structure with various reactive moieties (e.g. isocyanates), such as that taught by Leventis et al (Nano Letters, 2002, 2(9), 957-960 and U.S. published application 20040132846A1). If the resulting chemical structure results in a Si—O—X linkage, the group is readily susceptible to hydrolytic scission in the presence of water.

Wet gels frequently exhibit structures with mass fractal features consisting of co-continuous solid and pore liquid phases where the pore liquid phase can occupy as much as 98% of the sample volume. Aerogels have structures that are very similar to that of the original gel because they are dried by supercritical processes that eliminate capillary forces that cause the gel structure to collapse. The structure of xerogels, in contrast, is significantly modified during drying due to the capillary forces acting on the solid network during the evaporative drying process. The magnitude of the capillary pressure exerted on the solid network during evaporation is inversely proportional to pore dimensions (e.g. pore radius), and thus can be extremely large when pore features are in the nanometer (10⁻⁹ meters) range. These surface tension forces created during evaporative drying cause the gel network to fold or condense during xerogel manufacture as the coordination number of the particles increases.

Stated differently, a xerogel is formed upon conventional (evaporative) drying of wet gels, that is by increase in temperature or decrease in pressure with concomitant large shrinkage (and mostly destruction) of the initially uniform gel body. This large shrinkage of a gel body upon evaporation of the pore liquid is caused by capillary forces acting on the pore walls as the liquid retreats into the gel body. This results in the collapse of the filigrane, the highly porous inorganic network of the wet gels. Collapse of the structure stops when the gel network becomes sufficiently strong to resist the compressive forces caused by the surface tension.

The resulting xerogel has a close packing globular structure and no larger pores were observed under TEM, which suggests that they are space filling. Thus the dried xerogel structure (which comprises both the skeletal and porous phases) is a contracted and distorted version of the original wet gel's structure. Because of the difference in drying procedures, xerogels and aerogels have very different structures and material properties. For instance, the surface area, pore volume, and number of sterically accessible pendant reactive groups to a typical Si atom is significantly higher on average in an aerogel structure (dried supercritically) than in the corresponding xerogel structure made with the same starting formulation but dried evaporatively. Stated differently, the solutions or mixtures generally used to prepare a xerogel cannot be used to prepare an aerogel simply by altering the drying conditions because the resultant product will not automatically have a density of an aerogel. Thus there are fundamental compositional differences between xerogels and aerogels that greatly affects their surface area, reactivity, pore volume, thermal conductivity, compressibility, mechanical strength, modulus, and many other properties.

Thus compared to xerogel, aerogels are expanded structures that often more closely resemble the structure of the solvent-filled gel. TEM micrographs of aerogels often reveal a tenuous assemblage of clusters that bound large interstitial cavities. Porosity measurement by nitrogen sorption also reveals the structural difference in nanometer size level, compared to the corresponding xerogel, the aerogel contains over twice the pore volume and the pore size is considerably greater as is evident from the larger amount of adsorption that occurs at high relative pressures (>0.9). See C. J. Brinker and G. W. Scherer, Sol-Gel Science, 1990, Chapter 9. Due to the structural difference between aerogel and xerogels, there is significant difference in the physical properties of these two classes of materials, such as dielectric constant, thermal conductivities, etc. Therefore, even if starting from an identical elemental composition, an aerogel and its corresponding xerogel are completely different materials, somewhat analogous to sugar granules and cotton candy, both of which are composed of the same sugar molecules.

Citation of documents herein is not intended as an admission that any is pertinent prior art. All statements as to the date or representation as to the contents of documents is based on the information available to the applicant and does not constitute any admission as to the correctness of the dates or contents of the documents.

### SUMMARY OF THE INVENTION

The present invention provides for producing solvent filled, nanostructured gel structures as well as the resultant fiber reinforced gel composites produced therefrom. The gel structures become nanoporous aerogels after all mobile phase solvents are extracted via a process such as supercritical fluid extraction. The formulation and processes provided by the present invention offer improved mechanical properties for aerogel monoliths and composites once extraction is complete. The novel, organically modified silica is referred as an ormosil [organically modified silica]. The invention provides an improvement in compression properties of aerogel composites, making them better suited for compression resistant applications such as vacuum insulation panels (VIP) and insulation for underwater oil and gas pipelines. Other improved qualities have been observed in the samples as described herein.

The ormosil matrix materials described in this invention are best derived from sol-gel processing, preferably composed of polymers (inorganic, organic, or inorganic/organic hybrid) that define a structure with very small pores (on the order of billionths of a meter). Fibrous materials are optionally added prior to the point of polymer gelation reinforce the matrix materials described in this invention. The preferred fiber reinforcement is preferably a lofty fibrous structure (batting), but may also include individual oriented or random microfibers. More particularly, preferred fiber reinforcements are based upon either organic (e.g. thermoplastic polyester, high strength carbon, aramid, high strength oriented polyethylene), low-temperature inorganic (various metal oxide glasses such as E-glass), or refractory (e.g. silica, alumina, aluminum phosphate, aluminosilicate, etc.) fibers.

Thus in a first aspect, the invention provides ormosil aerogels with an organic material, optionally covalently linked to the silica network of the aerogel, as a reinforcing component within the structure of the aerogel. The preferred embodiment is to have organic material covalently bonded via a non-hydrolyzable Si—C linkage between a carbon atom of the organic material and a silicon atom of the inorganic structures to minimize the amount of washout and loss during aerogel manufacturing steps such as solvent exchange and/or supercritical solvent extraction. The organic material may be an acrylate, a vinyl polymer composed of acrylate monomers, which are esters containing vinyl groups (two carbon atoms double bonded to each other, directly attached to the carbonyl carbon). Preferably, silica bonded polymethacrylate is used as the reinforcing component. The formulations described herein alter the mechanical strength of the gel structure, providing advantages to processability. In ormosil embodiments lacking covalent linkage between the organic material and the silicate network, possible interactions that associate the two include charge interactions, alignment of attracting dipoles, hydrophobic to hydrophobic (van der Waals) interactions, and hydrogen bonding.

The present invention may also be considered as based on the multiple bonded linear polymer reinforcement concept, as a composition having multiple Si—C attachment points between co-mingled inorganic and organic polymer domains is taught. One advantage provided by the present invention is the creation of stiffer inorganic organic hybrid aerogel from known hybrid materials, such as a silica/PMA blend. Several different PMA types, as non-limiting examples, may be incorporated into the silica network as described herein to improve the mechanical properties of the resulting ormosils. The polymethacrylate phase is preferably linked into the silica network by both covalent and hydrogen bonds. In the resulting PMA/silica ormosil aerogel, the multiple bonded PMA chains reinforce the fragile porous silica matrix, as illustrated in FIG. 1. This leads to a strong aerogel structure with flexural strength values that can exceed 100 psi. For the sake of comparison, “pure” silica aerogel materials of the same density have flexural strengths typically around 1-2 psi.

The present invention intimately and covalently combining organic polymer domains into the silica structure via Si—C linkages stiffens the structure, and importantly will lead to significant reduction of compression deformation in the aerogel composite. Additionally, the incorporation of the polymer domains gives rise to an increased compressive resilience, generating enhanced recovery toward an original thickness when compressively deformed. In thermal insulation applications, this compressive resistance and resilience offer significant advantage, as the ultimate thermal resistance in a given direction is a function of both the intrinsic thermal conductivity of a material as well as its thickness in that direction. It is well known to those trained in the art that loss of thickness can lead to diminishing thermal performance in insulation applications. The present invention provides significant advantage in applications where constant compressive force (such as in a vacuum panel or underwater insulated pipelines) or transient compressive loads are applied directly to the insulating material structure.

Despite their similar elemental composition, there are fundamental differences between the structures of acrylate/silica or PMMA/silica aerogel prepared according to the present invention and previously known PMMA/silica xerogels. This mainly reflects the structural differences between these two classes of materials in the nanometer scale.

In another aspect, the present invention provides for the incorporation of a nano reinforcement component into silica network, in order to improve the mechanical properties such as stiffness, hardness, and toughness of the resulting hybrid gels. The improvement on mechanical strength will reduce the chance of cracking during the gel preparation process, and lead to an aerogel with improved mechanical properties, such as higher flexural strength, lower compression deformation, etc.

In a further aspect, the present invention provides a method to prepare acrylate/silica or silica/PMA hybrid aerogel, in which the acrylate or PMA phase is attached to the silica phase by both hydrogen bonds and covalent bonds. The introduction of acrylate or PMA will not cause macroscopic phase separation in the resulting ormosil gel.

In yet another aspect, the invention provides a method for co-condensing trialkoxysilyl containing acrylate or polymethacrylate oligomer with silica precursors such as, but not limited to, hydrolyzed alkoxysilanes, and the subsequent procedure to obtained a acrylate/silica or PMA/silica aerogel. The introduction of a acrylate or PMA reinforcement component further increases the flexural and compression strength of the resulting ormosil hybrid monolith. A acrylate/silica or PMA/silica ormosil hybrid aerogel with flexural strength greater than 100 psi was produced by the method described herein.

The invention also provides for high strength and low deformation under compression (<10% under 17.5 psi, up to 98% recovery strain after 4000 psi loading) aerogel fiber reinforce composite materials. The improvement of mechanical properties in this hybrid aerogels was achieved without sacrificing other inherent properties of aerogel such as low density and low thermal conductivity. Acrylate/silica or PMA/silica hybrid aerogels described in the present invention can also be readily fabricated into a bead form.

Thus the invention provides an organically modified silica (ormosil) aerogel composition wherein the composition contains an acrylate family or polymer. The oligomer or polymer is preferably bonded into the silicate network of the ormosil aerogel by covalent bonds and/or hydrogen bonding. Preferably, the bonding between the silicate network and the oligomer and includes a Si—C bond between a silicon atom in the silicate network and a carbon atom of the oligomer or polymer. Thus the invention provides an oligomer, which is bonded into the silicate network of the aerogel.

Non-limiting examples of the oligomer include polyacrylates, polyalkylacrylates, polymethacrylates, polymethylmethacrylate, polybutylmethacrylate, polyethylmethacrylate, polypropylmethacrylate, poly(2-hydroxyethylmethacrylate), poly(2-hydroxypropylmethacrylate), poly(hexafluorobutylmethacrylate), poly(hexafluoroisopropylmethacrylate) or combinations thereof. The oligomer or polymer acts as nanoreinforcement component for the rigid silica matrix material.

The weight percentage of the oligomer or polymer may range from about 1 to about 95% by weight, preferably from about 5 to about 85% by weight as non-limiting examples. Other ranges include from about 10 to about 75%, about 15 to about 65%, about 20 to about 55%, about 25 to about 45%, and about 30 to about 35%.

The compositions of the invention may comprise a cross-linker to create multiple linkages between silica and the acrylate phase. The cross-linker, prior to attachment to the silicate network and oligomer, may be represented by the formula (R1-O)3Si—R2,
wherein R1-O is a generic hydrolysable group which may be cleaved from said cross-linker to form a covalent bond between the cross-linker and the silicate network, and
R2 is a group which forms a covalent bond with an acrylate, such as the vinyl portion of an acrylate monomer. Other non-limiting examples of R2 are moieties that are able to react with the carbon-carbon double bond (vinyl group) at one or both ends of an acrylate oligomer or polymer. Exemplary moieties are those that can undergo an addition or oxidation reaction with the double bond as well known in the art.

Thus R1-O— may be considered a hydrolysable group which is replaced by a bond to the silicate network. Non-limiting examples of R2 include other polymerisable groups which may be attached to a polyacrylate. Preferably, a cross-linker is an acrylate monomer that is an alkoxysilylacrylate.

Non-limiting examples of the cross-linker include trimethoxysilylpropyl methacrylate (TMSPM) and trimethoxysilylpropyl acrylate. Preferably, the cross-linker is trimethoxysilylpropyl methylmethacrylate.

The invention also provides a method of preparing trialkoxysilyl grafted polymethacrylate oligomer, by reacting TMSPM with an acrylate monomer, such as a methacrylate monomer in solvent at an elevated temperature. Non-limiting examples of the acrylate monomer include methylmethacrylate, butylmethacrylate, ethylmethacrylate, propylmethacrylate, 2-hydroxyethylmethacrylate, 2-hydroxypropylmethacrylate, hexafluorobutylmethacrylate, and hexafluoroisopropylmethacrylate.

A non-limiting example of the amount of the methacrylate monomer reactant in the solvent is higher than 50% w/w to allow a fast reaction. Effective solvents for conducting the reaction include, but are not limited to, methanol, ethanol, isopropanol, tetrahydrofuran, or combinations thereof.

Elevated temperatures include those between 60 to 90° C., or between 70 to 80° C. as non-limiting examples to allow thermal initiation to occur.

The invention further provides a method of co-condensing trialkoxysilyl grafted polymethacrylate oligomer with silica precursor in a solvent at ambient or elevated temperature, said method comprising steps of combining the trialkoxysilyl grafted organic polymer resin and silica precursor under hydrolytic conditions (typically in the presence of an acid catalyst) to facilitate silica condensation reactions and subsequently catalyzing gelation of the hybrid sol mixture to form the hybrid gel structure. Non-limiting examples of hydrolytic conditions include acid reflux, such as in the presence of HCl or other strong acid.

In the present invention, the trialkoxysilyl grafted oligomer reactant concentration is in the range between about 5 to about 50 weight percent against solvent, preferably about 10 to about 30 weight percent.

The reaction temperature is in the range between about 10 to about 90° C., about 10 to about 30° C., about 30 to about 50° C., about 50 to about 70° C., or about 70 to about 80° C.

Non-limiting examples of the silica precursor include alkoxysilane, partially hydrolyzed alkoxylsilanes, tetraethoxylsilane, partially hydrolyzed, condensed polymers of tetraethoxylsilane, tetramethoxylsilane, partially hydrolyzed, condensed polymers of tetramethoxylsilane, tetra-n-propoxysilane, partially hydrolyzed, condensed polymers of tetra-n-propoxysilane or combinations thereof. Partially hydrolyzed alkoxylsilanes include, but are not limit to, Silbond H5, Silbond 40 and its product family; Dynasil 40 and its family product; Dow Corning Z6818 and other Dow Corning resins.

The invention further provides a gel composition which can be used to produce an organically modified silica aerogel material, preferably a polymethacrylate containing ormosil aerogel monolith, as described herein. The gel composition may of course contain fibrous material to produce a fiber reinforced, acrylate or polymethacrylate containing, ormosil aerogel composite as described herein. The weight % of acrylate or polymethacrylate may be in the range between about 1 to about 90% in the resulting aerogel monolith or composite, preferably between about 5 to about 80%, about 10 to about 75%, about 15 to about 65%, about 20 to about 55%, about 25 to about 45%, or about 30 to about 35%.

The resultant aerogel monoliths of the invention preferably have a density between about 0.01 or about 0.08 to about 0.30 or about 0.35 g/cm³ (including from about 0.05 to about 0.25 g/cm³, from about 0.1 to about 0.20 g/cm³, from about 0.15 to about 0.20 g/cm³, from about 0.18 to about 0.25 g/cm³, or from about 0.18 to about 0.30 g/cm³). Thermal conductivity is less than 20 mW/mK in one atmosphere of air and at ambient temperature, preferably between about 9 to about 14 or about 19 mW/mK (including about 10, about 11, about 12, about 13, about 14, about 15, about 16, about 17, about 18 or about 19 mW/mK), and flexural strength of more than about 2 up to about 102 psi. The fiber reinforced aerogel composites of the invention preferably have a density between 0.10 to 0.20 g/cm³ (including about 0.12, about 0.14, about 0.16, or about 0.18 g/cm³), and thermal conductivity between 9 to 16 mW/mK (including about 10, about 11, about 12, about 13, about 14, or about 15 mW/mK), under ambient conditions.

The fiber reinforced aerogel composites of the invention preferably also have a low compression deformation below about 10% (or below about 8 or below about 6%) under a load of about 17.5 psi. Alternatively, the fiber reinforced aerogel composite may have high recovery strain up to about 94.5% (or up to about 90%, or up to about 85%) after 4000 psi compression.

A preferred aerogel material of the invention has a density less than 0.3 g/cm3 with a strain recovery of at least 10% after experiencing a dynamic compressive load of at least 100 psi. Of course all aerogels disclosed herein may be prepared in bead or other particulate form.

The invention also provides a method of producing an aerogel composition comprising:
providing a acrylate monomer or an acrylate oligomer;
reacting an alkoxylsilylalkyl containing group with said acrylate monomer or acrylate oligomer to form a reactant;
mixing said reactant with a silica precursor in a solvent at ambient or higher temperature to form a mixture; and
drying the mixture to produce an aerogel composition as described herein.

The method is preferably conducted in a solvent selected from methanol, ethanol, isopropanol, tetrahydrofuran or combinations thereof.

In additional embodiments, the invention provides a vacuum insulated panels (VIP) or insulation for a cold volume enclosure comprising a fiber reinforced aerogel composite with a low compression deformation of about 10% or less under the loading of 17.5 psi.

The details of one or more embodiments of the invention are set forth in the accompanying drawings and the description below. Other features, objects, and advantages of the invention will be apparent from the drawings and detailed description, and from the claims.

### BRIEF DESCRIPTION OF THE DRAWINGS

FIG. 1 illustrates silica aerogel porous matrix reinforced by multiple bonded polymethacrylate chains (1: Si—C covalent bonding; 2: Silica particles; 3: PMMA oligomer chains).

FIG. 2 illustrates the molecular structure of cross-linker trimethoxysilylpropyl methylmethacrylate.

FIG. 3 illustrates the formation of trimethoxysilyl containing polymethacrylate oligomer.

FIG. 4 illustrates a hydrolysis based condensation reaction between trimethoxysilyl containing polymethacrylate oligomer and alkoxysilane.

FIG. 5 shows the result of a three point bending flexural test of the PMMA/silica hybrid aerogel monolith of Example 1.

FIG. 6 shows the pore size distributions of the monolith of Example 1.

FIG. 7 shows the 29Si Solid state NMR spectra of the monolith of Example 1.

FIG. 8 shows the pore size distributions of the aerogel of Example 2.

FIG. 9 shows the 29Si Solid state NMR spectra of the aerogel of Example 2.

FIG. 10 shows the results of a three point bending flexural test of the PMMA/silica hybrid aerogel monolith of Example 3.

FIG. 11 shows a compression measurement of the fiber reinforced aerogel of Example 6.

FIG. 12 shows pore size distributions of the aerogel and xerogel of Example 6.

### DETAILED DESCRIPTION OF MODES OF PRACTICING THE INVENTION

The nano reinforcement component used in the present invention includes, but is not limited to, the PMA family of polymers, e.g., polymethyl methacrylate (referred as PMMA hereafter), polybutyl methacrylate (referred as PBMA hereafter), and polyhydroxyethyl methacrylate (referred as PHEMA hereafter).

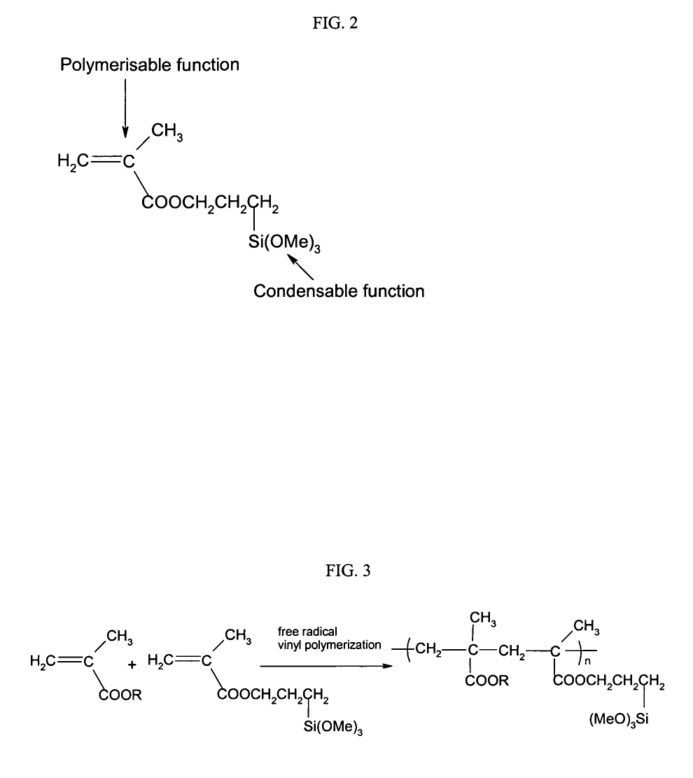

There are multiple ways to incorporate a polymer, or oligomer thereof, into a silica network. The present invention includes use of a cross linker trimethylsilyl propylmethymethacrylate (referred as TMSPM hereafter) to increase the miscibility of the two separated phase in the system. TMSPM has both a polymerable methacrylate component and condensable trimethoxysily function, as illustrated in FIG. 2.

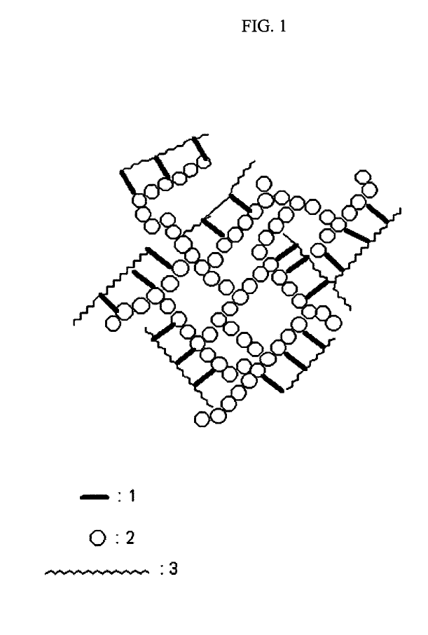

An advantage of the present invention is the incorporation of a non-hydrolyzable Si—C linkage that covalently spans the organic polymeric structure and the silicate network (see FIG. 1 for example). This linkage survives conventional processing conditions for aerogel manufacture intact, and can be stable to temperatures as high as 400° C. or above. Additionally, the present invention allows for formation of the covalent network structures between the organic polymer and the silicate domains in the sol stage, giving homogeneous or predominantly homogeneous mixing of the various phases. The resulting catalyzed sol can then gel to give a well-defined, amorphous gel structure with physical, chemical, and mechanical properties different from the individual phases considered separately.

The hydrolysis based condensation of the trialkoxysilyl grafted oligomer with silicic acids and esters based sols (derived from orthosilicates like tetraethylorthosilicate for instance), will covalently link the organic oligomer into the silica network, while the further polymerization of the organic polymer compound will further cross-link it into the PMA phase. In principle this cross-linker will act as a hook between the silica network and linear polymethacrylate elements. The presence of extensive hydrogen bonding between silanol groups of the silica network and the carbonyl group on the PMA may also favor the formation of the homogeneous gel. These interactions between polymeric and silica phase can enhance solution homogeneity and inhibit phase separations.

TMSPM was polymerized with methacrylate monomer to form trimethoxysilyl grafted polymethacrylate oligomer, as illustrated in FIG. 3. Thermal initiator, such as Azobisisobutyronitrile (referred as AIBN there after) or tert-butylperoxy-2-ethyl hexanoate, may be used to initiate the polymerization. The methacrylate monomer includes, but is not limit to, methylmethacrylate (referred as MMA hereafter), ethylmethacrylate (referred as EMA hereafter), butylmethacrylate (referred as BMA hereafter), hydroxyethylmethacrylate (referred as HEMA hereafter), hexafluorobutyl methacrylate (referred as HFBMA hereafter), etc. The polymerization was carried out in lower alcohol (C1 to C6) solutions at elevated temperatures between about 40 to about 100° C. and preferably from about 70 to about 80° C. To ensure a fast reaction, the reactant concentration in alcohol solution is preferably in the range between about 5 to about 95 weight percent, preferable from about 40 to about 70 weight percent. The mole ratio of TMSPM/methacylate monomer is in the range between about 1 to about 10, preferably about 1 to about 4. The resulting trimethoxysilyl grafted polymethacrylate oligomer should be of a relatively low molecular weight, soluble in common organic solvents.

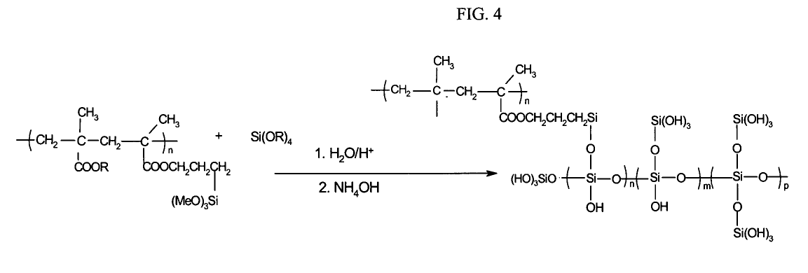

Generally the principal synthetic route for the formation of an ormosil aerogel is the hydrolysis and condensation of an appropriate silicon alkoxide, together with an organotrialkoxylsilane, as illustrated in FIG. 4. The most suitable silicon alkoxides are those having about from 1 to about 6 carbon atoms, preferably from 1 to about 3 carbon atoms, in each alkyl group. Specific examples of such compounds include tetraethoxysilane (referred as TEOS hereafter), tetramethoxysilane (referred as TMOS hereafter), and tetra-n-propoxysilane. These materials can also be partially hydrolyzed and stabilized at low pH as polymers of polysilicic acid esters such as polydiethoxysiloxane. These materials are commercially available in alcohol solution, for example Silbond®40, Silbond®25, Silbond® H5, and Dynasil®40. Higher molecular weight silicone resin can also be used in the ormosil formulation. Examples include, but are not limit to, Dow Corning Fox series, Dow Corning Z6075, Dow Corning MQ resin, etc.

It is understood to those skilled in the art that gel materials formed using the sol-gel process can be derived from a wide variety of metal oxide or other polymer forming species. It is also well known that sols can be doped with solids (IR opacifiers, sintering retardants, microfibers) that influence the physical and mechanical properties of the gel product. Suitable amounts of such dopants generally range from about 1 to about 40% by weight of the finished composite, preferably about 2 to about 30% using the compositions of this invention.

Variable parameters in the ormosil aerogel formation process include the type of alkoxide, solution pH, and alkoxide/alcohol/water ratio, silica/polymer ratio and monomer/cross linker ratio. Control of the parameters can permit control of the growth and aggregation of the matrix species throughout the transition from the “sol” state to the “gel” state. While properties of the resulting aerogels are strongly affected by the silica/polymer ratio, any ratio that permits the formation of gels may be used in the present invention.

Generally, the solvent used in the disclosed methods will be a lower alcohol, i.e. an alcohol having 1 to 6 carbon atoms, preferably 2 to 4, although other equivalent solvents can be used as is known in the art. Examples of other useful liquids include, but are not limited to, ethyl acetate, ethyl acetoacetate, acetone, dichloromethane, and the like.

For convenience, the alcogel route of forming ormosil gels and composites are provided below as a representative embodiment to illustrate how to create the precursors utilized by the invention. This is not intended to limit the present invention to the incorporation of any specific type of PMA into silica network. The invention is applicable to other ormosils with other similar concept structures.

After identification of the gel material to be prepared using the methods of this invention, a suitable silica alkoxide/triethoxylsilyl grafted PMA oligomer alcohol solution is prepared. The preparation of silica aerogel-forming solutions is well known in the art. See, for example, S. J. Teichner et al, Inorganic Oxide Aerogel, Advances in Colloid and Interface Science, Vol. 5, 1976, pp 245-273, and L. D. LeMay, et al., Low-Density Microcellular Materials, MRS Bulletin, Vol. 15, 1990, p 19. For producing ormosil gel monoliths, typically preferred ingredients are partially hydrolyzed alkoxysilane, trimethoxylsilyl grafted PMA oligomer, water, and ethanol (EtOH). All of the above mentioned ingredients may be mixed together at ambient or elevated temperature.

Partially hydrolyzed alkoxysilane includes and not limit to the following commercial materials: Silbond H5, Silbond 40 and its product family; Dynasil 40 and its product family. The preferred mole ratio of SiO₂ to water is about 0.1 to about 1:1, the preferred mole ratio of SiO₂ to MeOH is about 0.02 to about 0.5:1, and the preferred PMA/(PMA+SiO₂) weight percent is about 5 to about 90. The natural pH of a solution of the ingredients is about 5. While any acid may be used to obtain a lower pH solution, HCl, H₂SO₄ or HF are preferred acids. To generate a higher pH, NH₄OH is a preferred base.

A transparent ormosil gel monolith with about 1 to about 80 weight % (preferably about 5 to about 70%) loading of PMA was formed after the addition of condensation catalyst, according to the scheme illustrated in FIG. 4. The catalyst may be NH₄OH, NH₄F, HF, or HCl as non-limiting examples. The monolith will turn opaque after CO₂ supercritical extraction. The resulting ormosil aerogel monoliths have a density range from about 0.05 to about 0.40 and thermal conductivity range from about 10 to about 18 mW/mK. The reinforcement effect of PMA leads to great improvement of mechanical properties. Up to 102.2 psi flexural strength at rupture was measured on a 0.3 g/cm³ density PHEMA/silica aerogel. This particular ormosil aerogel monolith deformed less than 1% after the loading of 100 psi. As used herein, “deformation” or “deform” refers to the extent of change in an aerogel after application of load wherein the extent may be expressed as a ratio (or a percentage based thereon) of the difference in aerogel size, before and after application of load, to aerogel size before application of load.

For fiber-reinforced containing ormosil aerogel composites, pre-polymerized silica precursors (e.g. Silbond® H5 and its family) are preferred as the silica precursor. The effect of the other variation factors is similar to those in the preparation of ormosil monoliths.

As used herein, a lofty batting is defined as a fibrous material that shows the properties of bulk and some resilience (with or without full bulk recovery). Non-limiting examples of lofty battings that may be used are described in published U.S. Patent Application document U.S. 2002/0094426. In preferred embodiments of the invention, a batting for use in the present invention is “lofty” if it contains sufficiently few individual filaments (or fibers) that it does not significantly alter the thermal properties of the reinforced composite as compared to a non-reinforced aerogel body of the same material. Generally, and upon looking at a cross-section of a final aerogel composite comprising such batting, the cross-sectional area of the fibers is less than about 10% of the total surface area of that cross section, preferably less than about 8%, and most preferably less than about 5%.

The preferred form is a soft web of this material. The use of a lofty batting reinforcement material minimizes the volume of unsupported aerogel while avoiding substantial degradation of the thermal performance of the aerogel. Batting preferably refers to layers or sheets of a fibrous material, commonly used for lining quilts or for stuffing or packaging or as a blanket of thermal insulation.

Batting materials that have some tensile strength are advantageous for introduction to the conveyor casting system, but are not required. Load transfer mechanisms can be utilized in the process to introduce delicate batting materials to the conveyor region prior to infiltration with prepared sol flow.

Suitable fibrous materials for forming both the lofty batting and the x-y oriented tensile strengthening layers include any fiber-forming material. Particularly suitable materials include: fiberglass, quartz, polyester (PET), polyethylene, polypropylene, polybenzimid-azole (PBI), polyphenylenebenzo-bisoxasole (PBO), polyetherether ketone (PEEK), polyarylate, polyacrylate, polytetrafluoroethylene (PTFE), poly-metaphenylene diamine (Nomex), poly-paraphenylene terephthalamide (Kevlar), ultra high molecular weight polyethylene (UHMWPE) e.g. Spectra™, novoloid resins (Kynol), polyacrylonitrile (PAN), PAN/carbon, and carbon fibers.

The resulting fiber reinforced PMA/silica aerogel composite have a density between 0.05 to 0.25 g/cm³, and thermal conductivity between 12 to 18 mW/mK. The reinforcement effect of PMA leads to a great improvement of compression property of the aerogel composite. Less than 10% compression deformation was observed in the examples of this ormosil aerogel under the loading of 17.5 psi. The high strength fiber reinforced PMA/silica aerogel composite with density at 0.18 g/cm³ recover up to 94.5% of its original thickness after compression at 4000 psi.

Having now generally described the invention, the same will be more readily understood through reference to the following examples which are provided by way of illustration, and are not intended to be limiting of the present invention, unless specified.

### EXAMPLES

Further details and explanation of the present invention may be found in the following non-limiting specific examples, which describe the manufacture of silicon boned linear polymer containing ormosil aerogel monoliths and fiber reinforced aerogel composites in accordance with the present invention and test results generated there from.

The non-limiting examples are provided so that one skilled in the art many more readily understand the invention. In the examples weights are expressed as grams (g). Monomer MMA, BMA, HEMA, together with thermal initiator Azobisisobutyronitrile (AIBN) were purchased from Aldrich; cross-linker TMSPM was obtained from Ashland Chemicals as Dow Corning Z6030 silane.

### Example 1

This example illustrates the formation of a polymethylmethacrylate (PMMA) modified silica aerogel monolith and fiber reinforced composite with 56.9 weight percent loadings of PMMA. 1.0 g of AIBN was added to a mixture of 10 g of MMA, 24.8 g of TMSPM and 20 g of ethanol, following by vigorous stirring at 70 to 80° C. for 0.5 hr. Trimethoxysilyl grafted polymethymethacrylate oligomer was obtained as a viscous liquid in concentrated ethanol solution. 9.9 g 0.1M HCl aqueous solution was added into a mixture consisting of the above trimethoxysilyl grafted polymethymethacrylate oligomer ethanol solution, 60 g of silica precursor Silbond H5, 1.0 g of Polyethylene glycol methacrylate (Mn: 526) and 300 g of ethanol. This mixture was refluxed at 70 to 75° C. for 2 hours.

The obtained solution can be gelled in 14 minutes by addition of 12.8 g ethanol diluted ammonia solution (5/95 v/v, 29% NH₃ aqueous solution against ethanol). Both ormosil monolith and fiber reinforced gel composite were obtained from this example. Wet gels were aged in ethanol diluted ammonia solution (5/95 v/v, 29% NH₃ aqueous solution against ethanol) for 1 day and ethanol diluted hexamethyldisilazane (5/95 v/v, HMDS against ethanol) for 3 days.

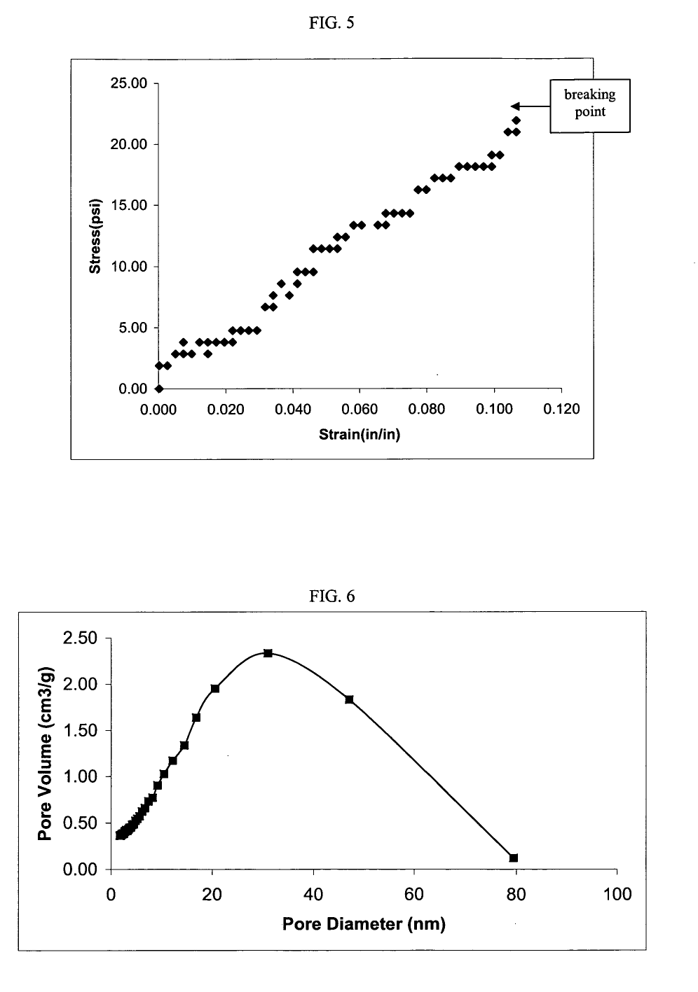

Both PMMA/Silica ormosil aerogel monolith and fiber reinforced aerogel composites were obtained from this example after CO₂ supercritical extraction. Aerogel monolith of this example shows a density of 0.16 g/cm³; thermal conductivity of 10.8 mW/mK under ambient conditions; and flexural strength at rupture of 21.9 psi (illustrated as the three point test in FIG. 5). Quartz fiber reinforced aerogel composite of this example shows a density of 0.15 g/cm³; and thermal conductivity of 15.0 mW/mK. Nitrogen sorption measurement shows that the aerogel monolith of this example has a BET surface area of 695 m²/g and total pore volume of 2.08 cm³/g, The pore size distribution of this sample is rather broad, ranged from 2 to 80 nm, as shown in FIG. 6.

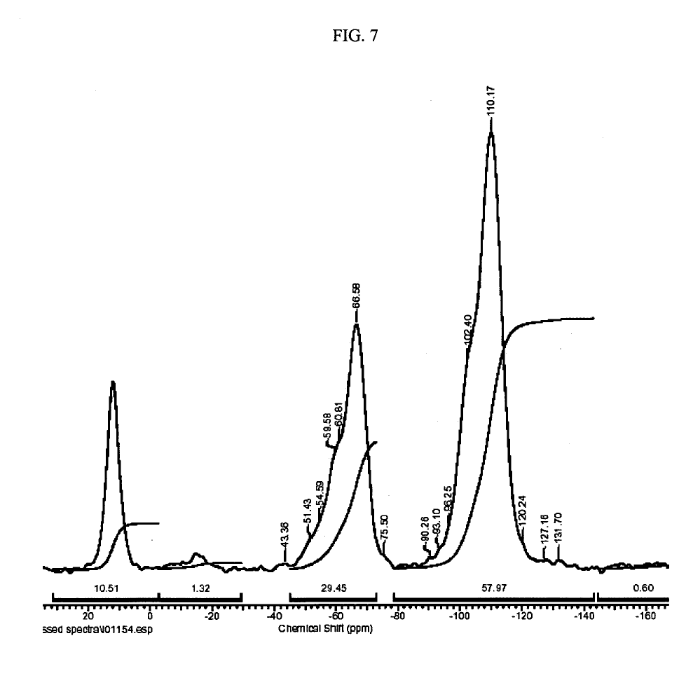

The local environment around silicon centers in silicate has been found to give rise to characteristic ²⁹Si chemical shifts, and those correlations have been used to establish the kind of environments present in silicate based materials by ²⁹Si MAS NMR spectroscopy. As illustrated in FIG. 7, there is one peak at −110 ppm and with a shoulder at −100 ppm, which corresponds to silicates with Q₃ and Q₄ substructures; one peak at 10 ppm corresponding to trimethysiloxane functions; and one peak (with a shoulder) at −66 ppm and a shoulder at −60 ppm, corresponding to the organically modified silicate T functions with substructure T₂ and T₃, as illustrated in FIG. 7. The presence of T species is the direct evidence of the formation of C—Si covalent bonding between the organic and silica phase in the aerogel.

### Example 2

This example illustrates the formation of a polybutylmethacrylate modified silica aerogel monolith and fiber reinforced composite with 61.0 weight percent loadings of PBMA. 1.4 g of AIBN was added to a mixture of 14 g of BMA, 24.8 g of TMSPM and 14 g of ethanol, following by vigorous stirring at 70 to 80° C. for 0.5 hr. Trimethoxysilyl grafted polybutylmethacrylate oligomer was obtained as a viscous liquid in concentrated ethanol solution. 9.9 g 0.1M HCl aqueous solution was added into a mixture consisting of the above trimethoxysilyl grafted polybutylmethacrylate oligomer ethanol solution, 60 g of silica precursor Silbond H5 and 300 g of ethanol. This mixture was refluxed at 70 to 75° C. for 2 hours.

The obtained solution can be gelled in 5 minutes by addition of 10.0 g ethanol diluted ammonia solution (5/95 v/v, 29% NH₃ aqueous solution against ethanol) and 2.5 g of 1.0M ammonium fluoride aqueous solution. Both ormosil monolith and fiber reinforced gel composite were obtained from this example. Wet gels were aged in ethanol diluted ammonia solution (5/95 v/v, 29% NH₃ aqueous solution against ethanol) for 1 day and ethanol diluted hexamethyldisilazane (5/95 v/v, HMDS against ethanol) for 3 days.

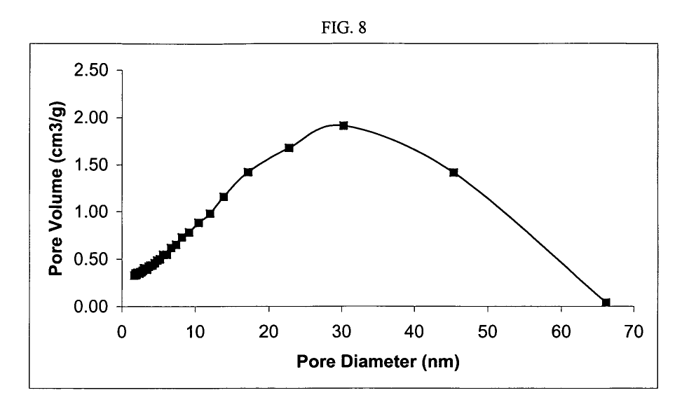

Both PBMA/Silica ormosil aerogel monolith and fiber reinforced aerogel composite were obtained from this example after CO₂ supercritical extraction. Aerogel monolith of this example shows a density of 0.17 g/cm³; thermal conductivity of 12.7 mW/mK under ambient conditions; and flexural strength at rupture of 9.7 psi. Quartz fiber reinforced aerogel composite of this example shows a density of 0.11 g/cm³; and thermal conductivity of 17.5 mW/mK. Nitrogen sorption measurement shows that the aerogel monolith of this example has a BET surface area of 611 m ²/g and total pore volume of 1.68 cm³/g. The pore size distribution of this sample is rather broad, ranging from 2 to 65 nm, as shown in FIG. 8.

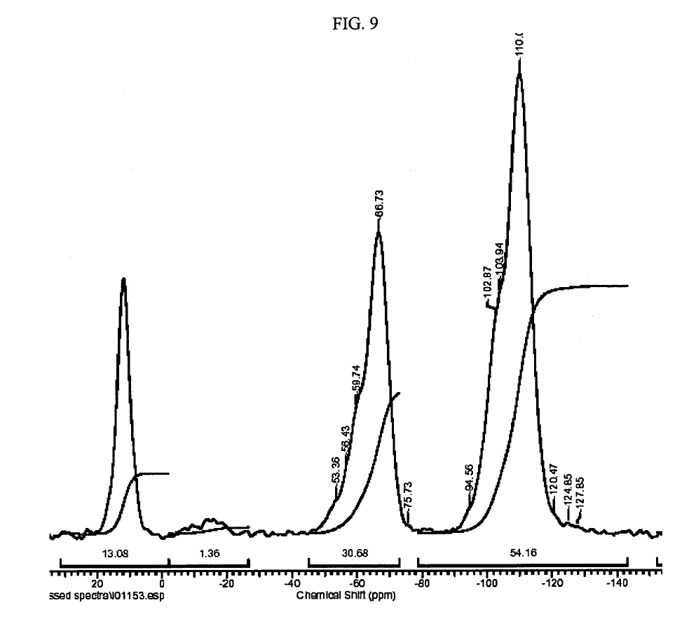

As illustrated in FIG. 9, the aerogel shows one peak at −110 ppm and with a shoulder at −100 ppm, which corresponds to silicates with Q₃ and Q₄ substructures; one peak at 10 ppm corresponding to trimethysiloxane functions; and one peak (with a shoulder) at −66 ppm and a shoulder at −60 ppm, corresponding to the organically modified silicate T functions with substructure T₂ and T₃, as illustrated in FIG. 9. The presence of T species is the direct evidence of the formation of C—Si covalent bonding between the organic and silica phase in the aerogel.

### Example 3

This example illustrates the formation of a polyhydroxyethylmethacrylate modified silica aerogel monolith and fiber reinforced composite with 83.2 weight percent loadings of PHEMA. 1.3 g of AIBN was added to a mixture of 13 g of HEMA, 24.8 g of TMSPM, following by vigorous stirring at 70 to 80° C. for 0.5 hr. Trimethoxysilyl grafted polymethymethacrylate oligomer was obtained as a viscous liquid in concentrated ethanol solution. 8.1 g 0.1M HCl aqueous solution was added into a mixture consisting of the above trimethoxysilyl grafted polyhydroxyethylmethacrylate oligomer ethanol solution and 200 g of ethanol. This mixture was refluxed at 70 to 75° C. for 45 minutes.

The obtained solution can be gelled in 8 hours at 55° C. after addition of 2.1 g ethanol diluted ammonia solution (25/75 v/v, 29% NH₃ aqueous solution against ethanol). Ormosil monoliths were obtained from this example. Wet gels were aged in ethanol diluted ammonia solution (5/95 v/v, 29% NH₃ aqueous solution against ethanol) for Iday and ethanol diluted hexamethyldisilazane (5/95 v/v, HMDS against ethanol) for 3 days.

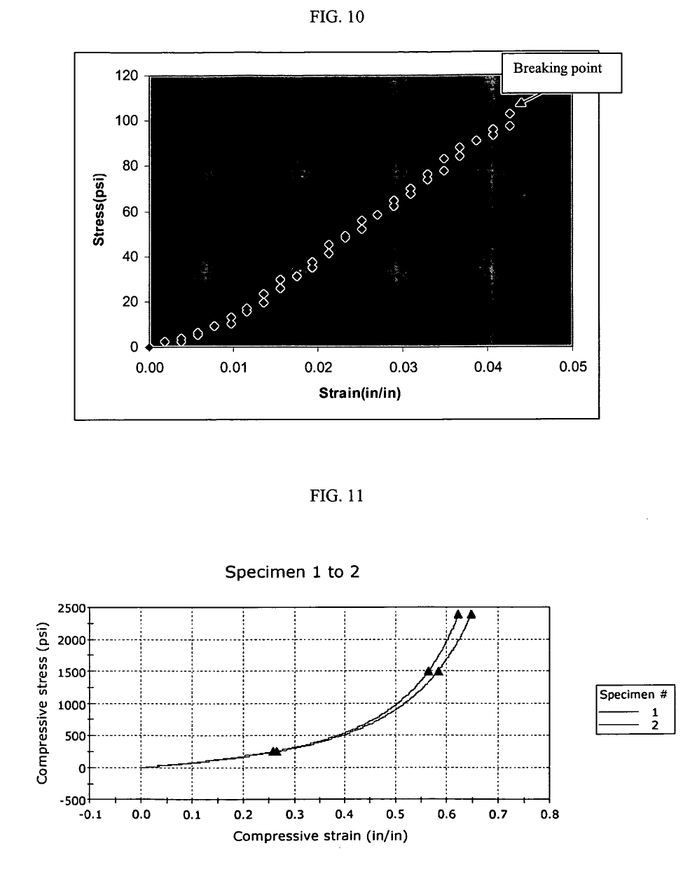

PHEMA/Silica ormosil aerogel monoliths were obtained from this example after CO₂ supercritical extraction. The aerogel monolith of this example shows a density of 0.32 g/cm³; thermal conductivity of 18.5 mW/m-K under ambient conditions; and flexural strength at rupture of 102.3 psi measured by ASTM D790 (Standard Test Methods for Flexural Properties of Unreinforced and Reinforced Plastics and Electrical Insulating Materials). See FIG. 10.

### Example 4

This example illustrates the formation of a polymethylmethacrylate modified silica aerogel monolith and fiber reinforced composite with 20 weight percent loadings of PMMA. 0.5 g of AIBN was added to a mixture of 5 g of MMA, 6.2 g of TMSPM and 5 g of ethanol, following by vigorous stirring at 70 to 80° C. for 0.5 hr. Trimethoxysilyl grafted polymethylmethacrylate oligomer was obtained as a viscous liquid in concentrated ethanol solution. 14.1 g 0.1M HCl aqueous solution was added into a mixture consisting of the above trimethoxysilyl grafted polymethymethacrylate oligomer ethanol solution, 150 g of silica precursor Silbond H5, and 135 g of ethanol. This mixture was refluxed at 70 to 75° C. for 2 hours.

The obtained solution can be gelled in 5 minutes by addition of 190 ml of ethanol and 1.74 g ethanol diluted ammonia solution (50/50 v/v, 29% NH₂ aqueous solution against ethanol). Both ormosil monolith and fiber reinforced gel composite were obtained from this example. Wet gels were aged in ethanol diluted ammonia solution (5/95 v/v, 29% NH₃ aqueous solution against ethanol) for 1 day and ethanol diluted hexamethyldisilazane (5/95 v/v, HMDS against ethanol) for 3 days.

Both PMMA/Silica ormosil aerogel monolith and fiber reinforced aerogel composite were obtained from this example after CO₂ supercritical extraction. Aerogel monolith of this example shows a density of 0.15 g/cm³; thermal conductivity of 13.7 mW/mK under ambient conditions; and flexural strength at rupture of 12.5 psi. Quartz fiber reinforced aerogel composite of this example shows a density of 0.16 g/cm³; and thermal conductivity of 16.3 mW/mK. Compression test show a 12.2% deformation of this composite under a loading of 17.5 psi.

### Example 5

This example illustrates the formation of a polymethylmethacrylate modified silica aerogel monolith and fiber reinforced composite with 20 weight percent loadings of PMMA. 0.5 g of AIBN was added to a mixture of 5 g of MMA, 6.2 g of TMSPM and 5 g of ethanol, following by vigorous stirring at 70 to 80° C. for 0.5 hr. Trimethoxysilyl grafted polymethylmethacrylate oligomer was obtained as a viscous liquid in concentrated ethanol solution. 28.2 g of 0.1M HCl aqueous solution was added into a mixture consisting of the above trimethoxysilyl grafted polymethymethacrylate oligomer ethanol solution, 150 g of silica precursor Silbond H5, and 121 g of ethanol. This mixture was refluxed at 70 to 75° C. for 0.5 hours.

The obtained solution can be gelled in 13 minutes by addition of 136 ml of ethanol and 9.30 g ethanol diluted ammonia solution (5/95 v/v, 29% NH₃ aqueous solution against ethanol). Both ormosil monolith and fiber reinforced gel composite were obtained from this example. Wet gels were aged in ethanol diluted hexamethyldisilazane (5/95 v/v, HMDS against ethanol) for 2 days.

PMMA/Silica ormosil aerogel fiber reinforced aerogel composites were obtained from this example after CO₂ supercritical extraction. Quartz fiber reinforced aerogel composite of this example shows a density of 0.17/cm³; thermal conductivity of 12.8 mW/mK. Compression test show a 10.9% deformation of this composite under a loading of 17.5 psi, and 84.2% recovery strain after a loading of 4000 psi.

### Example 6

This example illustrates the formation of a polybutylmethacrylate modified silica aerogel monolith and fiber reinforced composite with 20 weight percent loadings of PBMA. 2.8 g of AIBN was added to a mixture of 28 g of BMA, 24.8 g of TMSPM and 28 g of ethanol, following by vigorous stirring at 70 to 80° C. for 0.5 hr. Trimethoxysilyl grafted polybutylmethacrylate oligomer was obtained as a viscous liquid in concentrated ethanol solution. 147.15 g 0.1M HCl aqueous solution was added into a mixture consisting of the above trimethoxysilyl grafted polybutylmethacrylate oligomer ethanol solution, 787.5 g of silica precursor Silbond H5, and 610 ml of ethanol. This mixture was refluxed at 70 to 75° C. for 0.5 hours.

The obtained solution can be gelled in 11 minutes by addition of 28 g ethanol diluted ammonia solution (5/95 v/v, 29% NH₃ aqueous solution against ethanol). Both ormosil monolith and fiber reinforced gel composite were obtained from this example. Wet gels were aged in ethanol diluted hexamethyldisilazane (5/95 v/v, HMDS against ethanol) for 3 days.

Both PBMA/Silica ormosil aerogel monolith and fiber reinforced aerogel composite were obtained from this example after CO₂ supercritical extraction. Aerogel monolith of this example shows a density of 0.16 g/cm³; and thermal conductivity of 13.2 mW/mK under ambient conditions. Quartz fiber reinforced aerogel composite of this example shows a density of 0.18 g/cm³; and thermal conductivity of 13.5 mW/mK. Compression test show 94.5% recovery strain after a loading of 4000 psi.

### Example 7

This example illustrates the formation of a polybutylmethacrylate modified silica aerogel monolith and fiber reinforced composite with 20 weight percent loadings of PBMA. 2.8 g of AIBN was added to a mixture of 28 g of BMA, 24.8 g of TMSPM and 28 g of ethanol, following by vigorous stirring at 70 to 80° C. for 0.5 hr. Trimethoxysilyl grafted polybutylmethacrylate oligomer was obtained as a viscous liquid in concentrated ethanol solution. 147.15 g 0.1M HCl aqueous solution was added into a mixture consisting of the above trimethoxysilyl grafted polybutylmethacrylate oligomer ethanol solution, 787.5 g of silica precursor Silbond H5, and 610 ml of ethanol. This mixture was refluxed at 70 to 75° C. for 0.5 hours.

The obtained solution can be gelled in 7 minutes by addition of ²50 g of ethanol and 30 g ethanol diluted ammonia solution (5/95 v/v, 29% NH₃ aqueous solution against ethanol). Both ormosil monolith and fiber reinforced gel composite were obtained from this example. Wet gels were aged in ethanol diluted ammonia solution (5/95 v/v, 29% NH₃ aqueous solution against ethanol) for 1 day and ethanol diluted hexamethyldisilazane (5/95 v/v, HMDS against ethanol) for 3 days.

Both PMMA/Silica ormosil aerogel monolith and fiber reinforced aerogel composite were obtained from this example after CO₂ supercritical extraction. Aerogel monolith of this example shows a density of 0.16 g/cm³; and thermal conductivity of 13.2 mW/mK under ambient conditions. Quartz fiber reinforced aerogel composite of this example shows a density of 0.16 g/cm³; and thermal conductivity of 13.1 mW/mK. Compression test show a 7.7% deformation of this composite under a loading of 17.5 psi, and 87.4% recovery strain after a loading of 4000 psi.

### Example 8

This example illustrates the formation of a polymethylmethacrylate modified silica aerogel beads with 33.6 weight percent loadings of PMMA. 3.9 g of AIBN was added to a mixture of 39 g of MMA, 48.75 g of TMSPM and 41.7 g of ethanol, following by vigorous stirring at 70 to 80° C. for 0.5 hr. Trimethoxysilyl grafted polybutylmethacrylate oligomer was obtained as a viscous liquid in concentrated ethanol solution. 58.3 g 0.1M HCl aqueous solution was added into a mixture consist the above trimethoxysilyl grafted polybutylmethacrylate oligomer ethanol solution, 589 g of silica precursor Silbond H5, and 764 ml of ethanol. This mixture was refluxed at 70 to 75° C. for 1 hours.

The obtained solution was mixed with 1.4 wt % aqueous ammonia solution in a 2 to 1 volume ratio to form a ormosil sol. This sol was added dropwise into a large amount of non-miserable solvent such as silicone oil under constant stirring at ambient temperature. The PMMA/silica pre-condensed sol gelled while being dispersed into the silicone oil, resulting in appropriately spherical, bead-like hydrogel. Wet gels were washed with ethanol twice and aged in ethanol diluted hexamethyldisilazane (10/90 v/v, HMDS against ethanol) for 1 day. PMMA/Silica hybrid aerogel beads were obtained from this example after CO₂ supercritical extraction.

### Example 9

This example illustrates the formation of polyester fiber reinforced PMMA/silica aerogel composites with 15% loading of PMMA. 0.90 g of ter-butyl peroxy-2-ethyl hexanoate was added to a mixture of 40 g of MMA, 24.8 g of TMSPM and 18.3 g of methanol, following by vigorous stirring at 70 to 80° C. for 0.5 hr. Trimethoxysilyl containing polymethacrylate oligomer was obtained as a viscous liquid in concentrated ethanol solution.

30.97 g trimethysilyl containing polymethacrylate oligomer was mixed with 622.28 g of Sibond H5®, 155.93 g of ethanol, 68.08 g of water and 42.0 g of 0.1M aqueous HCl for 1 hour under ambient conditions. The resulting solution was further mixed with 12.87 g of Alcoblack, 2.57 g of carbon fiber and 527.78 g of ethanol for another 5 minute and gelled in 3 minutes by addition of 71.1 g of ethanol and 2.4 g of 29% aqueous ammonia solution. Fiber reinforced gel composite was obtained from this example. Wet gels were aged in ethanol diluted ammonia solution (5/95 v/v, 29% NH₃ aqueous solution against ethanol) for 1 day and ethanol diluted hexamethyldisilazane (5/95 v/v, HMDS against ethanol) for 1 day, respectively.

Fiber reinforced hybrid aerogel composite was obtained from this example after CO₂ supercritical extraction. A coupon of fiber reinforced aerogel composite of this example shows a density of 0.14 g/cm³3; and thermal conductivity of 12.9 mW/mK under ambient conditions.

### Example 10

This example illustrates the formation of a carbon opacified fiber reinforced polymethylmethacrylate modified silica aerogel composite with 20 weight percent loadings of PMMA. 0.47 g of ter-butyl peroxy-2-ethyl hexanoate was added to a mixture of 7.8 g of MMA, 9.75 g of TMSPM and 4.22 g of methanol, following by vigorous stirring at 70 to 80° C. for 0.5 hr. Trimethoxysilyl grafted polymethylmethacrylate (PMMA) oligomer was obtained as a viscous liquid in concentrated methanol solution.

8.04 g of the above trimethoxysilyl grafted PMMA oligomer solution was further dissolved in a solution consisting of 6 g of THF, 30 g of ethanol and 14.7 g 0.1M HCl aqueous solution, and mixed with 79.1 g of silica precursor Silbond H5, at ambient temperature for 1 hr.

The obtained solution was mixed with a solution consisting of 2.57 g of carbon black solution (alcoblack®) and 45 g of ethanol, and finally gelled in 5.5 minutes by addition of 21.3 g of ethanol and 0.3 g of ammonia solution (29% NH₂ aqueous solution). Polyester fiber reinforced gel composite were obtained from this example. Wet gels were aged in ethanol diluted ammonia solution (5/95 v/v, 29% NH₃ aqueous solution against ethanol) for 1 day and ethanol diluted hexamethyldisilazane (5/95 v/v, HMDS against ethanol) for 3 days.

A unitary fiber reinforced aerogel composite was obtained from this example after CO₂ supercritical extraction. By way of comparison, the wet gels were also placed in fume hood at ambient condition for 3 days. The result was a fragmented fiber reinforced xerogel composite.

The fiber reinforced aerogel composite of this example had a density of 0.16 g/cm³ with thermal conductivity of 15.7 mW/mK under ambient conditions. The fiber reinforced xerogel composite of this example had a density of 0.36 g/cm³ with thermal conductivity of 29.7 mW/mK under ambient conditions.

The coupon of this fiber reinforced opacified aerogel composite appeared to be very stiff. The compression measurement showed it deformed only 27% under the loading of 250 psi and 57% under the loading of 1500 psi, as shown in FIG. 11.

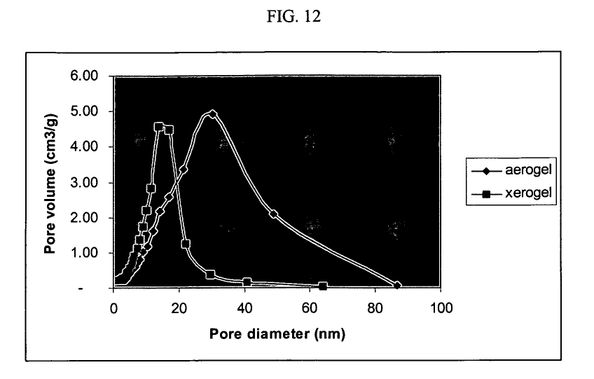

Nitrogen porosimetry also revealed the structural difference between aerogel and xerogel of this example at the nanometer size level. The aerogel had 2.97 cm3/g total pore volume and 30 nm median pore size, while the xerogel had 1.95 cc/g total pore volume and 17 nm median pore size, as shown in FIG. 12. The aerogel thus had significant higher total pore volume and bigger pore size compared to a xerogel counterpart.

All references cited herein are hereby incorporated by reference in their entireties, whether previously specifically incorporated or not. As used herein, the terms “a”, “an”, and “any” are each intended to include both the singular and plural forms.

Having now fully described this invention, it will be appreciated by those skilled in the art that the same can be performed within a wide range of equivalent parameters, concentrations, and conditions without departing from the spirit and scope of the invention and without undue experimentation. While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

1. An organically modified silica (ormosil) aerogel composition said composition comprising an acrylate family oligomer, which is bonded into the silicate network of the aerogel.

2. The composition of claim 1 wherein the said composition comprises a Si—C bond between a silicon atom in the silicate network and a carbon atom of the oligomer.

3. The composition of claim 1 wherein the oligomer is selected from polyacrylates, polyalkylacrylates, polymethacrylates, polymethylmethacrylate, polybutylmethacrylate, polyethylmethacrylate, polypropylmethacrylate, poly(2-hydroxyethylmethacrylate), poly(2-hydroxypropylmethacrylate), poly(hexafluorobutylmethacrylate), poly(hexafluoroisopropylmethacrylate) or combinations thereof.

4. The composition of claim 1 wherein the oligomer is present from 1 to 95% w/w or from 5 to 85% w/w.

5. The composition of claim 1 further comprising a cross-linker to create multiple linkages between silica and the oligomer.

6. The composition of claim 5 wherein the cross-linker, prior to attachment to the silicate network and oligomer, is represented by the formula (R¹—O)₃Si—R²
wherein R¹—O is a generic hydrolysable group which may be cleaved from said cross-linker to form a covalent bond between the cross-linker and the silicate network,
R² is a group which forms a covalent bond with an acrylate, such as the vinyl portion of an acrylate monomer.

7. The composition of claim 6 wherein the cross-linker is selected from trimethoxysilylpropyl methacrylate (TMSPM) and trimethoxysilylpropyl acrylate.

8. The composition of claim 6 wherein the crosslinker is prepared by reacting an alkoxysilylacrylate, preferably, trimethoxysilylpropyl methacrylate (TMSPM) or trimethoxysilylpropyl acrylate with an acrylate monomer in a solvent at elevated temperature, wherein the acrylate monomer is optionally selected from
methylmethacrylate, butylmethacrylate, ethylmethacrylate, propylmethacrylate, 2-hydroxyethylmethacrylate, 2-hydroxypropylmethacrylate, hexafluorobutylmethacrylate, and hexafluoroisopropylmethacrylate.

9. The composition of claim 8 wherein the solvent is selected from methanol, ethanol, isopropanol, tetrahydrofuran, or combinations thereof.

10. The composition of claim 8 wherein concentration of the methacrylate monomer reactant is higher than 50% w/w to allow a fast reaction and/or
wherein the reaction temperature is between 60 to 90° C. or between 70 to 80° C.

11. The composition of claim 1 in the form of beads or particles.

12. A method of producing an aerogel composition comprising:
providing a acrylate family oligomer;
reacting an alkoxylsilylalkyl containing group with said oligomer to form a reactant;
mixing said reactant with a silica precursor in a solvent at ambient or higher temperature to form a mixture; and
drying the mixture to produce an aerogel composition.

13. The method of claim 12 further comprising a solvent selected from methanol, ethanol, isopropanol, tetrahydrofuran or combinations thereof.

14. The method of claim 12 wherein the silica precursor is selected from alkoxysilane, partially hydrolyzed alkoxysilanes, tetraethoxylsilane, partially hydrolyzed, condensed polymers of tetraethoxylsilane, tetramethoxylsilane, partially hydrolyzed, condensed polymers of tetramethoxylsilane, tetra-n-propoxysilane, partially hydrolyzed, condensed polymers of tetra-n-propoxysilane or combinations thereof.

15. The method of claim 12 wherein the reaction temperature is in the range between 10 and 90° C., 10 and 30° C., or 70 and 80° C.

16. The method of claim 12 wherein the aerogel composition has
a density between 0.01 and 0.35 g/cm³;
thermal conductivity less than 20 mW/mK in one atmosphere of air and at ambient temperature; and/or
flexural strength more than 2 psi.

17. The method of claim 14 wherein the aerogel composite has a strain recovery of up to 94.5% after 4000 psi compression or
a density less than 0.3 g/cm³ with a strain recovery of at least 10% after experiencing a dynamic compressive load of at least 100 psi.

18. A vacuum insulated panels (VIP) or insulation form for cold volume enclosure, said VIP or insulation form comprising a fiber reinforced aerogel composite with a low compression deformation of about 10% or less under the loading of 17.5 psi.

19. The fiber reinforced aerogel composite of claim 18.
